(19) United States
(12) Patent Application Publication
(10) Pub. No.: US 2020/0378293 A1
(43) Pub. Date: Dec. 3, 2020

(54) IMPROVED DIESEL PARTICULATE FILTER LINEARITY WITH THIN ASH LAYER

(71) Applicant: Cummins Emission Solutions Inc., Columbus, IN (US)

(72) Inventors: Qiang Liu, Columbus, IN (US); Harsha S. Surenahalli, Columbus, IN (US); Kevin A. Spencer, Columbus, IN (US); Rayomand Dabhoiwala, Columbus, IN (US)

(73) Assignee: Cummins Emission Solutions Inc., Columbus, IN (US)

(21) Appl. No.: 16/970,659

(22) PCT Filed: Feb. 19, 2018
(86) PCT No.: PCT/US2018/018591

§ 371 Date: Aug. 18, 2020

(51) Int. Cl. F01N 9/00; F01N 3/022; F01N 3/023; B01D 46/44; B01D 46/00; B01D 53/94

(52) U.S. Cl. CPC F01N 9/002; F01N 3/0222; F01N 3/023; B01D 46/446; B01D 46/448; B01D 46/444; B01D 2279/30; B01D 46/0063; B01D 53/9477; F01N 2330/06; F01N 2900/1606; F01N 2900/1602; F01N 2900/1411; B01D 46/442

(57) ABSTRACT

A particulate filter for use in an exhaust aftertreatment system includes a ceramic substrate and an ash layer deposited atop the ceramic substrate. The ash layer has a uniform ash density of at least 0.4 g/L of the ceramic substrate. A method of depositing ash layers in a particulate filter of an exhaust aftertreatment system includes providing a ceramic substrate, preconditioning the ceramic substrate, depositing at least one ash layer atop the ceramic substrate during the preconditioning, monitoring uptake of soot into the particulate filter by measuring an increase in pressure drop across the particulate filter.

### TECHNICAL FIELD

The present application relates generally to the field of aftertreatment systems for internal combustion engines.

### BACKGROUND

Diesel particulate filters (DPFs) have been broadly used to capture and remove particulate matter (PM) from exhaust streams of diesel engines. A catalyzed, monolithic ceramic substrate is one filter material conventionally used in such particulate filters because of its ability to withstand harsh temperature and durability requirements in the exhaust aftertreatment and to capture and oxidize soot to CO₂ for subsequent release. Current DPF technologies are aimed at identifying the right pore size distribution and mean pore size diameter (MPD) to aid in increasing filtration efficiencies and improving DPF pressure drop linearity. However, variation on DPF porosity has resulted in high cost on product development as well as negative tradeoffs in DPF performance. For example, reductions in MPD often lead to increases in pressure drop across the particulate filters, thereby impacting engine back pressure. Moreover, additional challenges arise in maintaining the balance between maximizing filtration capability with the filter's quality factor (i.e. ratio of differential pressure to available area) over a period of time.

### SUMMARY

Implementations described herein relate to a particulate filter for use in an exhaust aftertreatment system comprising: a ceramic substrate; and an ash layer deposited atop the ceramic substrate; wherein the ash layer has a uniform ash density of at least 0.4 g/L of the ceramic substrate.

In one implementation, a pressure drop across the particulate filter increases linearly as thickness of the ash layer increases.

In another implementation, a method of depositing ash layers in a particulate filter of an exhaust aftertreatment system, comprises: providing a ceramic substrate; preconditioning the ceramic substrate; and depositing at least one ash layer atop the ceramic substrate during the preconditioning.

In one implementation, the step of depositing comprises: monitoring an exhaust flow of soot into the particulate filter and an aftertreatment temperature, wherein the aftertreatment temperature is controlled above a predetermined temperature threshold for at least a predetermined amount of time, and wherein the exhaust flow is controlled above a predetermined flow threshold for the predetermined amount of time.

In one implementation, when the aftertreatment temperature decreases below the predetermined temperature threshold, or when the exhaust flow decreases below the predetermined exhaust threshold, a regeneration is triggered.

In one implementation, when the soot is present in the particulate filter in an amount greater than a predetermined amount threshold, a regeneration is triggered.

In one implementation, the regeneration comprises: burning at least a portion of the soot collected in the particulate filter; and depositing at least one ash layer as a result of the burning.

In one implementation, the method further comprises monitoring uptake of soot into the particulate filter by measuring an increase in pressure drop across the particulate filter.

In another implementation, a method of depositing ash layers in a particulate filter of an exhaust aftertreatment system, comprises: providing a ceramic substrate; preconditioning the ceramic substrate; depositing at least one ash layer atop the ceramic substrate during the preconditioning, the depositing comprising: controlling an exhaust flow of soot into the particulate filter above a predetermined flow threshold for a predetermined amount of time; controlling an aftertreatment temperature above a predetermined temperature threshold for at least the predetermined amount of time; triggering a regeneration of the ceramic substrate, the regeneration comprising burning at least a portion of the soot collected in the particulate filter; and depositing at least one ash layer as a result of the burning; and monitoring uptake of soot into the particulate filter by measuring an increase in pressure drop across the particulate filter.

In one implementation, the step of triggering commences when (A) the exhaust flow rate is not maintained above the predetermined flow threshold for the predetermined amount of time; (B) the aftertreatment temperature is not maintained above the predetermined temperature threshold for at least the predetermined amount of time; or (C) the soot is present in the particulate filter in an amount greater than a predetermined amount threshold.

In one implementation, the step of depositing at least one ash layer atop the ceramic substrate is configured to reduce soot load uncertainty of the particulate filter and/or improve particulate matter and particulate number filtration efficiency of the particulate filter prior to the step of preconditioning.

In one implementation, the step of depositing at least one ash layer atop the ceramic substrate is configured to cause a linear pressure drop across the particulate filter as thickness of the ash layer increases.

In one implementation, the increase in pressure drop across the particulate filter is a linear pressure drop.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block schematic diagram of an example selective catalytic reduction system having an example reductant delivery system for an exhaust system;

FIG. 2 is a schematic depicting an exemplary, ash-loaded DPF structure.

FIG. 3 is a schematic depicting the effects on pressure drop linearity (y) as a function of soot load (x) for clean and ash-coated DPFs in comparison with perfectly linear systems; and

FIG. 4 illustrates the process timeline in loading the soot onto the DPF.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for aftertreatment of internal combustion engines. The various concepts introduced above and discussed in greater detail below may be implemented in any of numerous ways, as the described concepts are not limited to any particular manner of implementation. Examples of specific implementations and applications are provided primarily for illustrative purposes. Embodiments described herein can result in benefits such as providing an improved diesel particulate filter for diesel engines that overcomes the challenges described above. These and other advantageous features will be apparent to those reviewing the present disclosure.

### Overview

In some exhaust systems, a sensor module may be located downstream of a selective catalytic reduction (SCR) catalyst to detect one or more emissions in the exhaust flow after the SCR catalyst. For example, a NOₓ sensor, a CO sensor, and/or a particulate matter sensor may be positioned downstream of the SCR catalyst to detect NOₓ, CO, and/or particulate matter within the exhaust gas exiting the exhaust of the vehicle. Such emission sensors may be useful to provide feedback to a controller to modify an operating parameter of the aftertreatment system of the vehicle. For example, a NOₓ sensor may be utilized to detect the amount of NOₓ exiting the vehicle exhaust system and, if the NOₓ detected is too high or too low, the controller may modify an amount of reductant delivered by a dosing module. A CO and/or a particulate matter sensor may also be utilized.

### Overview of Aftertreatment System

FIG. 1 depicts an aftertreatment system 100 having an example reductant delivery system 110 for an exhaust system 190. The aftertreatment system 100 includes a particulate filter, for example a DPF 102, the reductant delivery system 110, a decomposition chamber or reactor pipe 104, a SCR catalyst 106, and a sensor 150.

The DPF 102 is configured to remove particulate matter, such as soot, from exhaust gas flowing in the exhaust system 190. The DPF 102 includes an inlet, where the exhaust gas is received, and an outlet, where the exhaust gas exits after having particulate matter substantially filtered from the exhaust gas and/or converting the particulate matter into carbon dioxide.

The decomposition chamber 104 is configured to convert a reductant, such as urea, aqueous ammonia, or diesel exhaust fluid (DEF), into ammonia. The decomposition chamber 104 includes a reductant delivery system 110 having a dosing module 112 configured to dose the reductant into the decomposition chamber 104. In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the DPF 102 to receive the exhaust gas containing NOₓ emissions and an outlet for the exhaust gas, NOₓ emissions, ammonia, and/or remaining reductant to flow to the SCR catalyst 106.

The decomposition chamber 104 includes the dosing module 112 mounted to the decomposition chamber 104 such that the dosing module 112 may dose the reductant into the exhaust gases flowing in the exhaust system 190. The dosing module 112 may include an insulator 114 interposed between a portion of the dosing module 112 and the portion of the decomposition chamber 104 to which the dosing module 112 is mounted. The dosing module 112 is fluidly coupled to one or more reductant sources 116. In some implementations, a pump 118 may be used to pressurize the reductant from the reductant source 116 for delivery to the dosing module 112.

The dosing module 112 and pump 118 are also electrically or communicatively coupled to a controller 120. The controller 120 is configured to control the dosing module 112 to dose reductant into the decomposition chamber 104. The controller 120 may also be configured to control the pump 118. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 106 includes inlet in fluid communication with the decomposition chamber 104 from which exhaust gas and reductant is received and an outlet in fluid communication with an end of the exhaust system 190.

The exhaust system 190 may further include an oxidation catalyst, for example a diesel oxidation catalyst (DOC) in fluid communication with the exhaust system 190 (e.g., downstream of the SCR catalyst 106 or upstream of the DPF 102) to oxidize hydrocarbons and carbon monoxide in the exhaust gas.

In some implementations, the DPF 102 may be positioned downstream of the decomposition chamber or reactor pipe 104. For instance, the DPF 102 and the SCR catalyst 106 may be combined into a single unit, such as a DPF with SCR-coating (SDPF). In some implementations, the dosing module 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190, such as a tip of the sensor 150 may extend into a portion of the exhaust system 190. In other implementations, the sensor 150 may receive exhaust gas through another conduit, such as a sample pipe extending from the exhaust system 190. While the sensor 150 is depicted as positioned downstream of the SCR catalyst 106, it should be understood that the sensor 150 may be positioned at any other position of the exhaust system 190, including upstream of the DPF 102, within the DPF 102, between the DPF 102 and the decomposition chamber 104, within the decomposition chamber 104, between the decomposition chamber 104 and the SCR catalyst 106, within the SCR catalyst 106, or downstream of the SCR catalyst 106. In addition, two or more sensor 150 may be utilized for detecting a condition of the exhaust gas, such as two, three, four, five, or six sensors 150, with each sensor 150 located at one of the foregoing positions of the exhaust system 190.

### DPF Ceramic Substrates

As mentioned above, existing DPF technologies are aimed at optimizing porosity (i.e. pore size distribution and mean pore size diameter (MPD)) as a means for improving DPF pressure drop linearity (i.e. linear increases in pressure drop with increasing amounts of soot captured by the DPF (“soot load”)). However, optimization techniques typically result in increased in pressure drop uncertainty due to depth bed filtration in the particulate filters (adversely impacting engine back pressure) and difficulties in maintaining the balance between maximizing filtration capability and the filter's quality factor over a period of time.

The present disclosure utilizes a thin layer of ash on DPF substrate walls to encourage inhibition of deep bed filtration behaviors such that the accuracy of soot load prediction by changes in pressure (i.e. pressure drop) are improved. In the deep-bed filters, the mean pore size of filter media is larger than the mean diameter of collected particles, which are deposited on the media through a combination of depth filtration mechanisms that are driven by various force fields. During depth filtration, as diesel exhaust is forced to flow through the DPF substrate wall, soot particles are captured in the pores of the wall. The filtration is a combination of diffusion, interception, inertial impaction, gravitational deposition, electrostatic deposition, and thermophoresis. The combination of these filtration mechanisms is referred to as depth filtration.

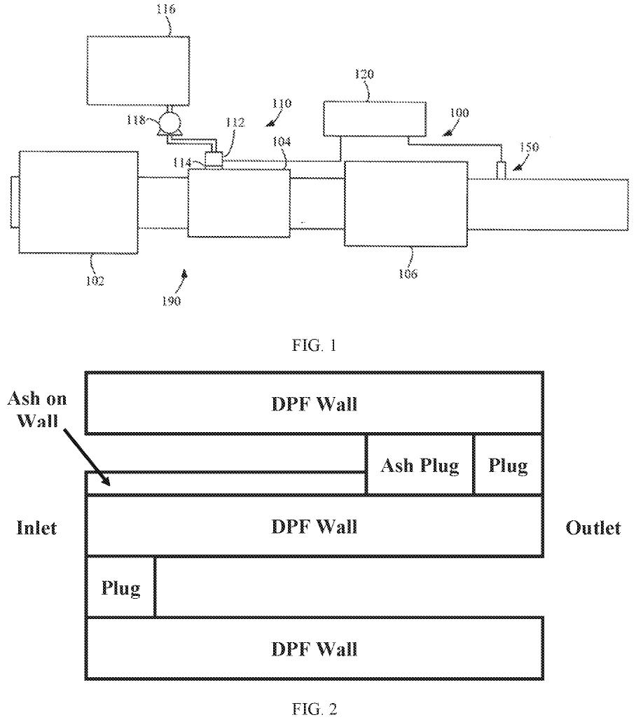

As shown in FIG. 2, after the DPF substrate wall is sufficiently filled with soot particles, the soot begins accumulating on filter walls, leading to formation of a soot cake layer on DPF walls. The soot cake layer is highly porous and has a high filtration efficiency. The soot cake layer has a lower pressure drop than depth filtration and has a relatively steady increase in pressure drop with the increase of filtration cake. Depth filtration is characterized by lower filtration efficiency and higher pressure drop than cake filtration. By adding ash onto the walls of the DPF substrate, an ash layer is created that mimics cake filtration and thereby minimizing deep bed filtration behaviors to encourage surface-type (i.e. cake) filtration mechanisms.

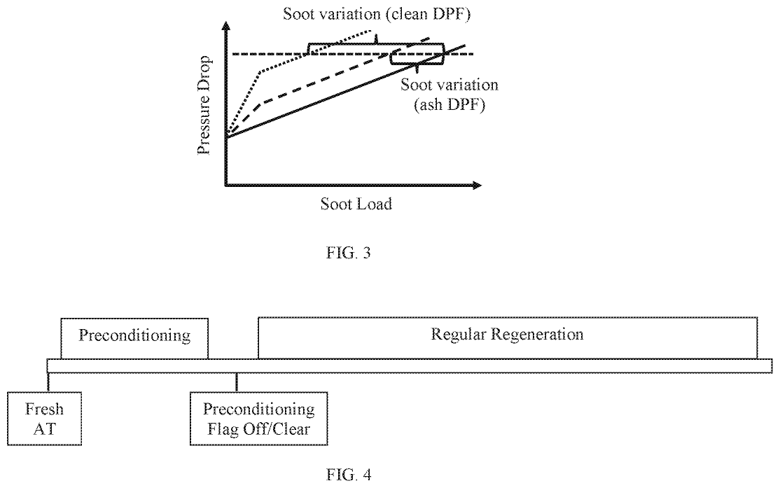

FIG. 3 is a schematic depicting the effects on pressure drop linearity (y) as a function of soot load (x) for clean and ash-coated DPF systems in comparison with perfectly linear DPF systems. Soot particles form in an engine's combustion chamber as a result of incomplete combustion and are normally removed from the DPF through regeneration. As greater amounts of soot are collected in a DPF (i.e. soot loading), the increase in pressure drop may be used to estimate the amount of soot collected. Periodically, the soot collected is burned off in a DPF regeneration process, which leaves ash behind. Estimation of the soot loading amount is prone to considerable error due to hysteresis of the transient pressure drop resulting from combination of deep-bed and cake filtration modes, fluctuations in exhaust gas temperature and flow rate, and engine pulsation. For a given pressure drop, soot variation of the clean DPF from perfectly linear systems is much greater than the soot variation of the ash-coated DPF from perfectly linear systems. Thus, ash-coated DPFs retain more of a linear pressure drop character than non-coated DPFs and as a result, are able to more accurately predict the amount of soot accumulated in the DPF.

Thus, the disclosure presented herein describes a thin ash layer having a uniform ash density of at least 0.4 g/L of DPF built during a DPF early stage (i.e. break-in period) which improves DPF linearity, reduces soot prediction variation, and helps create a robust regeneration strategy for improved fuel economy of an internal combustion engine.

Deposition of Ash Layers onto DPFs

In one embodiment, the process of depositing ash onto a DPF substrate includes using control software (operated by a controller) to initially precondition the clean DPF substrate (i.e. a DPF substrate without soot uptake or ash deposition). The control software is also responsible for subsequently monitoring soot uptake by the DPF by calculating delta pressure based soot load estimates (DPSLE) over time. The controller monitors exhaust flow and/or aftertreatment temperature such that the aftertreatment temperature is maintained above a predetermined threshold for at least a predetermined amount of time (tunable). If the aftertreatment temperature is below the predetermined threshold, the system triggers a regeneration to expedite preconditioning. The amount of soot accumulated in the filter wall is significantly less than the amount of soot in the soot cake layer. Though a small fraction as compared to the soot cake layer, the soot in the filter wall significantly contributions toward the overall pressure drop across the DPF. Uncertainties in the amount of soot in the filter wall results in a large variation of the soot load estimate based on the pressure drop. In this manner, uptake of the soot is measured during a preconditioning whereby the load is estimated from an increase in filter pressure drop.

The preconditioning is used to break in the engine and the aftertreatment system by stabilizing the performance of the engine and degreening the aftertreatment system, respectively. The objective of preconditioning is to stabilize the performance of the engine and aftertreatment system. A new engine requires stabilization time (i.e., break-in period) during which the engine components wear and settle into a stable state. At the conclusion of the break-in period, the aftertreatment reaches a stable operating state where its performance is repeatable. As the soot load is increased, pressure drop also steadily increases (i.e. see FIG. 3). This increase in pressure drop is utilized by the engine control module (ECM) to estimate the amount of the soot accumulated in the DPF. The estimated soot load is used to trigger a filter regeneration. High soot load uncertainty leads to uncontrolled regeneration and consequently, DPF failure. By decreasing the uncertainty in the soot load estimate, the DPF soot load can be more accurately predicted and prevent DPF failure.

FIG. 4 illustrates the process timeline in loading the soot onto the DPF. As stated above, the process flow begins with the control software stabilizing the clean DPF substrate prior to ash deposition at a time period beginning the exhaust aftertreatment (“Fresh AT”). In the subsequent precondition period (i.e. engine break-in period), soot is loaded on the DPF substrate and monitored by measuring increases in pressure drop.

In order to achieve maximum ash loading at the highest rate of ash deposition, the engine's duty cycle may be adjusted during the precondition period. This is conducted by modifying engine parameters such as injection timing, exhaust gas recirculation (EGR) percent, and fuel pressure. Ash production from engines has a strong correlation to oil consumption of the engine, which itself has a strong correlation to changes in the load on the engine. Therefore, by increasing the load on the engine, greater ash deposition on the DPF may be achieved. Engine load is also correlated with rapid changes in cylinder pressure. Thus, increases in ash deposition on the DPF may also be achieved by increasing the magnitude of pressure changes in the cylinder. The cylinder pressure change is due to modifications in the engine control parameters such are injection timing. As a result of the increased ash loading, linearity of the pressure drop is enhanced to thereby yield more accurate soot load predictions. Only ash deposited during the precondition period and before clearance of the precondition flag contributes to linearity; additional ash deposited prior to or after the precondition period generally does not contribute to linearity.

The ash layer described herein may have a uniform ash density of at least 0.4 g/L of DPF and functions to (1) improve DPF linearity without altering DPF substrate properties, (2) reduce soot prediction variation, (3) help create a robust regeneration strategy, and (4) take advantage of the precondition period to load ash on the DPF without conflicting with regulatory requirements.

The term “controller” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, the separation of various system components in the implementations described above should not be understood as requiring such separation in all implementations, and it should be understood that the described components and systems can generally be integrated in a single product or packaged into multiple products embodied on tangible media.

As utilized herein, the terms “about,” “approximately,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims. Additionally, it is noted that limitations in the claims should not be interpreted as constituting “means plus function” limitations under the United States patent laws in the event that the term “means” is not used therein.

The terms “coupled” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

The terms “fluidly coupled,” “in fluid communication,” and the like as used herein mean the two components or objects have a pathway formed between the two components or objects in which a fluid, such as water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various exemplary implementations is illustrative only and not restrictive in character. All changes and modifications that come within the spirit and/or scope of the described implementations are desired to be protected. For example, while the use of this technology is exemplified for ash layers deposited on diesel particulate filter (DPF) substrates, it should be understood that the present disclosure is not limited to this application. Rather diesel particulate filters for diesel engines are merely one embodiment meant to exemplify automotive applications. It should also be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A particulate filter for use in an exhaust aftertreatment system comprising:
a ceramic substrate;
an ash layer deposited atop the ceramic substrate, wherein the ash layer has a uniform ash density of at least 0.4 g/L of the ceramic substrate; and
a controller configured to trigger regeneration of a soot layer to form the ash layer in response to determining that a pressure drop across the particulate filter due to the soot layer is above a threshold pressure value.

2. The particulate filter of claim 1, wherein a pressure drop across the particulate filter increases linearly as thickness of the ash layer increases.

3. A method of depositing ash layers in a particulate filter of an exhaust aftertreatment system, comprising:
providing a ceramic substrate;
preconditioning the ceramic substrate; and
depositing at least one ash layer atop the ceramic substrate during the preconditioning, wherein the step of depositing comprises:
depositing soot on the particulate filter, and
triggering regeneration of the soot to form the at least one ash layer in response to determining that a pressure drop across the particulate filter due to the soot layer is greater than a threshold pressure value.

4. The method of claim 3, wherein the step of depositing at least one ash layer atop the ceramic substrate is configured to reduce soot load uncertainty of the particulate filter and/or improve particulate matter and particulate number filtration efficiency of the particulate filter prior to the step of preconditioning.

5. The method of claim 3, wherein the step of depositing at least one ash layer atop the ceramic substrate is configured to cause a linear pressure drop across the particulate filter as thickness of the ash layer increases.

6. The method of claim 3, wherein the step of depositing comprises:
monitoring an exhaust flow of soot into the particulate filter and an aftertreatment temperature,
wherein the aftertreatment temperature is controlled above a predetermined temperature threshold for at least a predetermined amount of time, and
wherein the exhaust flow is controlled above a predetermined flow threshold for the predetermined amount of time.

7. The method of claim 6, further comprising monitoring uptake of soot into the particulate filter by measuring an increase in pressure drop across the particulate filter.

8. The method of claim 6, wherein, when the aftertreatment temperature decreases below the predetermined temperature threshold, or when the exhaust flow decreases below the predetermined exhaust threshold, a regeneration is triggered.

9. The method of claim 6, wherein, when the soot is present in the particulate filter in an amount greater than a predetermined amount threshold, a regeneration is triggered.

10. The method of claim 8, wherein the regeneration comprises:
burning at least a portion of the soot collected in the particulate filter; and
depositing at least one ash layer as a result of the burning.

11. A method of depositing ash layers in a particulate filter of an exhaust aftertreatment system, comprising:
providing a ceramic substrate;
preconditioning the ceramic substrate;
depositing at least one ash layer atop the ceramic substrate during the preconditioning, the depositing comprising:
controlling an exhaust flow of soot into the particulate filter above a predetermined flow threshold for a predetermined amount of time;
controlling an aftertreatment temperature above a predetermined temperature threshold for at least the predetermined amount of time;
triggering a regeneration of the ceramic substrate, the regeneration comprising burning at least a portion of the soot collected in the particulate filter; and
depositing at least one ash layer as a result of the burning; and
monitoring uptake of soot into the particulate filter by measuring an increase in pressure drop across the particulate filter
wherein the step of triggering is performed in response to determining that a pressure drop across the particulate filter due to the soot layer is greater than a threshold pressure value.

12. The method of claim 11, wherein the step of triggering further commences when (A) the exhaust flow rate is not maintained above the predetermined flow threshold for the predetermined amount of time; (B) the aftertreatment temperature is not maintained above the predetermined temperature threshold for at least the predetermined amount of time; or (C) the soot is present in the particulate filter in an amount greater than a predetermined amount threshold.

13. The method of claim 11, wherein the increase in pressure drop across the particulate filter is a linear pressure drop.
